(19) United States
(12) Patent Application Publication
(10) Pub. No.: US 2023/0274235 A1
(43) Pub. Date: Aug. 31, 2023

(54) COORDINATION OF SUPPLEMENTAL EMPLOYEE RESOURCE ALLOCATION REQUESTS

(71) Applicants: Allison Michelle Scaia, St. Louis, MO (US); Kyrie S. Davidson, Boca Raton, FL (US); Emma J. Goldman, West Hartford, CT (US); Alicia Lucille Harvey, Minneapolis, MN (US)

(72) Inventors: Allison Michelle Scaia, St. Louis, MO (US); Kyrie S. Davidson, Boca Raton, FL (US); Emma J. Goldman, West Hartford, CT (US); Alicia Lucille Harvey, Minneapolis, MN (US)

(21) Appl. No.: 17/680,812

(22) Filed: Feb. 25, 2022

(51) Int. Cl. G06Q 10/10

(52) U.S. Cl. CPC G06Q 10/1057; G06Q 10/1091

(57) ABSTRACT

A resource allocation request coordination framework may include a resource allocation request data store that contains electronic records for a set of resource allocation requests associated with risk relationships between an enterprise and an entity. Based on resource allocation request parameters retrieved from the resource allocation request data store, a back-end application computer server may automatically update information in a supplemental resource allocation request data repository (storing supplemental resource allocation requests from parties associated with the entity). The back-end application computer server may then apply analytics to the information in the resource allocation request data store and the supplemental resource allocation request data repository to generate a recommendation. The back-end application computer server may also facilitate an exchange of data with a remote administrator device to support an interactive graphical dashboard display, including the recommendation, via a distributed communication network.

### TECHNICAL FIELD

The present application generally relates to computer systems and more particularly to computer systems that are adapted to accurately and/or automatically coordinate supplemental employee resource allocation requests.

### BACKGROUND

An enterprise may enter into risk relationships with various entities. For example, an insurer may issue workers’ compensation insurance policies to various employers. Parties, such as employees, may then submit claims (e.g., resource allocation requests to take a temporary leave and be absent from work) under those policies to be processed by the insurer in accordance with appropriate rules. The insurer and/or employer may also offer other types of insurance policies to employees, such as group benefit insurance policies (e.g., Short Term Disability (“STD”), Long Term Disability (“LTD”), accident insurance, etc.). Moreover, in some cases governmental laws or regulations may apply to certain leave requests (e.g., the Family Medical Leave Act (“FMLA”)). Note that a single incident may be covered by multiple sets of rules (e.g., a workers’ compensation claim might turn into an LTD claim). Having a person, such as an analyst, manually coordinate leave requests can be a time consuming and error prone task - especially when there are a substantial number of rule and/or requests that need to be processed (e.g., thousands of requests might be received each month). For example, medical information associated with a workers’ compensation insurance claim might need to be manually re-entered into an LTD processing system. Moreover, it can be difficult to analyze this information to recommend improvements for employers and/or employees.

It would therefore be desirable to provide improved systems and methods to accurately and/or automatically coordinate supplemental employee resource allocation requests. Moreover, results should be easy to access, understand, interpret, update, etc.

### SUMMARY OF THE INVENTION

According to some embodiments, systems, methods, apparatus, computer program code and means are provided to accurately and/or automatically coordinate supplemental employee resource allocation requests in a way that provides fast and useful results and that allows for flexibility and effectiveness when implementing those results.

Some embodiments are directed to a resource allocation request coordination framework that includes a resource allocation request data store with electronic records for a set of resource allocation requests associated with risk relationships between an enterprise and an entity. Based on resource allocation request parameters retrieved from the resource allocation request data store, a back-end application computer server may automatically update information in a supplemental resource allocation request data repository (storing supplemental resource allocation requests from parties associated with the entity). The back-end application computer server may then apply analytics to the information in the resource allocation request data store and the supplemental resource allocation request data repository to generate a recommendation. The back-end application computer server may also facilitate an exchange of data with a remote administrator device to support an interactive graphical dashboard display, including the recommendation, via a distributed communication network.

Some embodiments comprise: means for retrieving, by a computer processor of a back-end application computer server, information from a resource allocation request data store that contains electronic records for a set of resource allocation requests associated with risk relationships between the enterprise and an entity, each electronic record including an electronic record identifier and at least one resource allocation request parameter; based on resource allocation request parameters, means for automatically updating information in a supplemental resource allocation request data repository storing supplemental resource allocation requests from parties associated with the entity; means for applying analytics to the information in the resource allocation request data store and the supplemental resource allocation request data repository to generate a recommendation; and means for facilitating an exchange of data with a remote administrator device to support an interactive graphical dashboard display, including the recommendation, via a distributed communication network.

In some embodiments, a communication device associated with a back-end application computer server exchanges information with remote devices in connection with an interactive graphical administrator interface. The information may be exchanged, for example, via public and/or proprietary communication networks.

A technical effect of some embodiments of the invention is an improved and computerized way to accurately and/or automatically coordinate supplemental employee resource allocation requests in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates product connectivity for insurance claim processing.

FIG. 2 is an example of relationships between parties associated with insurance claim processing.

FIG. 3 illustrates enhanced product connectivity for insurance claim processing according to some embodiments.

FIG. 4 is a high-level block diagram of an employee resource allocation request coordination framework in accordance with some embodiments.

FIG. 5 illustrates a resource allocation request processing method according to some embodiments of the present invention.

FIG. 6 illustrates a connected claim experience in accordance with some embodiments.

FIG. 7 is an information flow that may let a single intake system receive claims (regardless of reason) according to some embodiments.

FIG. 8 is a workflow in accordance with some embodiments.

FIG. 9 is a display that shows what might trigger a creation of a leave from a WC claim in accordance with some embodiments.

FIG. 10 shows what an employee leave request might look like according to some embodiments.

FIG. 11 illustrates some workers’ compensation information that might be displayed in accordance with some embodiments.

FIG. 12 is an example of a letter that might be sent to an employee according to some embodiments.

FIG. 13 is an information flow for a new workers’ compensation lost time claim in accordance with some embodiments.

FIG. 14 is an information flow for ongoing updates to a workers’ compensation lost time claim according to some embodiments.

FIG. 15 is an information flow for a new, work-related, short term disability claim in accordance with some embodiments.

FIG. 16 is a summary display for integrated absence activity that may be provided to an employer according to some embodiments.

FIG. 17 is a more detailed absence display in accordance with some embodiments.

FIG. 18 is an individual employee multiple claims inquiry dashboard display according to some embodiments.

FIG. 19 is an individual employee single claim inquiry display in accordance with some embodiments.

FIG. 20 is a dashboard report display according to some embodiments.

FIG. 21 is a block diagram of an apparatus in accordance with some embodiments of the present invention.

FIG. 22 is a portion of supplemental resource allocation request data according to some embodiments.

FIG. 23 illustrates an administrator display in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data efficiency and usefulness associated with an employee resource allocation request coordination framework. The present invention is directed to more than merely a computer implementation of a routine or conventional activity previously known in the industry as it provides a specific advancement in the area of electronic record analysis by providing improvements in the operation of a computer system that facilitates the processing and coordination of resource allocation requests. The present invention provides improvement beyond a mere generic computer implementation as it involves the novel ordered combination of system elements and processes to provide improvements in the speed and ease of such processing. Some embodiments of the present invention are directed to a system adapted to automatically use analytics to generate recommendations for employer and employee improvements, etc. Moreover, communication links and messages may be automatically established, aggregated, formatted, exchanged, etc. to improve network performance (e.g., by reducing an amount of network messaging bandwidth and/or storage required to process leave requests, ensure compliance with governmental regulations, etc.).

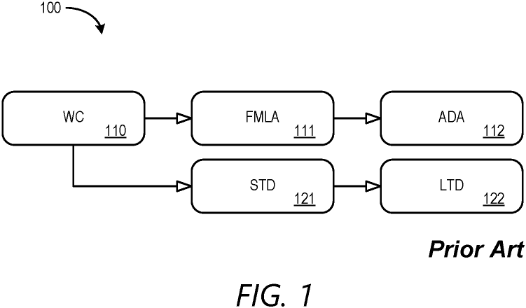

FIG. 1 illustrates 100 a typical example of product connectivity for insurance claim processing. Information from a Workers’ Compensation (“WC”) claim 110 may be used to initiate a Family Medical Leave Act (“FMLA”) leave request 111 to track time out of work. As used herein, the phrase “WC claim” may be associated with an insurance product that provides wage replacement and/or medical benefits to employees injured in the course of employment. A FMLA leave request 111 is associated with a US law that requires some employers to provide employees with job-protected, unpaid leave for qualified medical and family reasons (e.g., up to 12 work weeks of unpaid leave to care for a new child, care for a seriously ill family member, to recover from a serious illness, etc.). If the FMLA leave request 111 is exhausted and an employee remains out of work, an Americans with Disabilities Act (“ADA”) claim 112 may be initiated.

In some cases, a Short-Term Disability (“STD”) claim 121 is initiated in conjunction with the WC claim 110 if the employer or employee has a particular type of coverage. The phrase “STD claim” 121 may refer to insurance for an employee’s earned income against the risk that a disability prevents completion of work functions for a short period of time (e.g., an injury or illness that causes physical impairment or incapacity to work). If that particular type of coverage is not applicable, the STD 121 may be initiated after the WC claim 110 is denied. If an STD claim 121 is created, it may transition to a Long-Term Disability (“LTD”) claim 122. If there is not already an STD claim 121, the LTD claim 122 might be initiated, for example, if the injured worker remains out of work at the mid-point of an LTD elimination period.

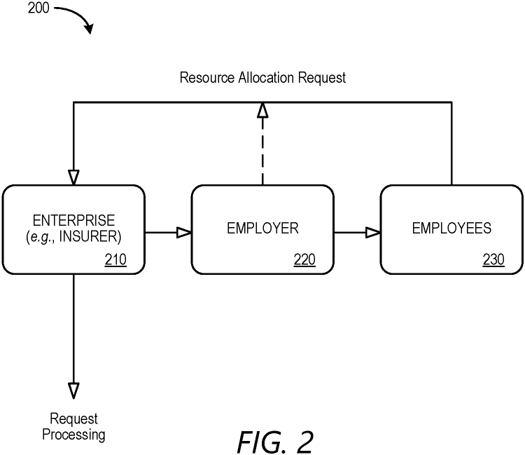

The product connectivity illustrated 100 in FIG. 1 may be coordinated by an enterprise for an entity, such as an insurer for an employer. FIG. 2 is an example 200 of relationships between parties during insurance claim processing. An enterprise 210, such as an insurer, may enter into a risk relationship with an employer 220 who has a number of employees 230. As used herein, the phrase “risk relationship” may refer to, for example, an agreement that actually shifts risk between parties (e.g., an insurance policy), an agreement to handle some aspects of processing associated with insurance (e.g., insurance claim processing, etc.). Note that not every coordination associated with an enterprise is connected to insurance products. For example, there are some products included that are more like services or service offerings and have no insurance aspect (e.g., ADA or Leave Management). That is, these are not products with an insurance “premium” that is collected to pay out benefits. Employees 230 may submit resource allocation requests (e.g., associated with insurance claims and/or leave absence requests) to the enterprise 210 who can then process those requests in accordance with applicable rules or business logic (e.g., insurance policy rules, governmental regulations, etc.). In some cases, the employer 220 might provide a resource allocation request directly to the enterprise 210 (e.g., as illustrated by the dashed arrow in FIG. 2).

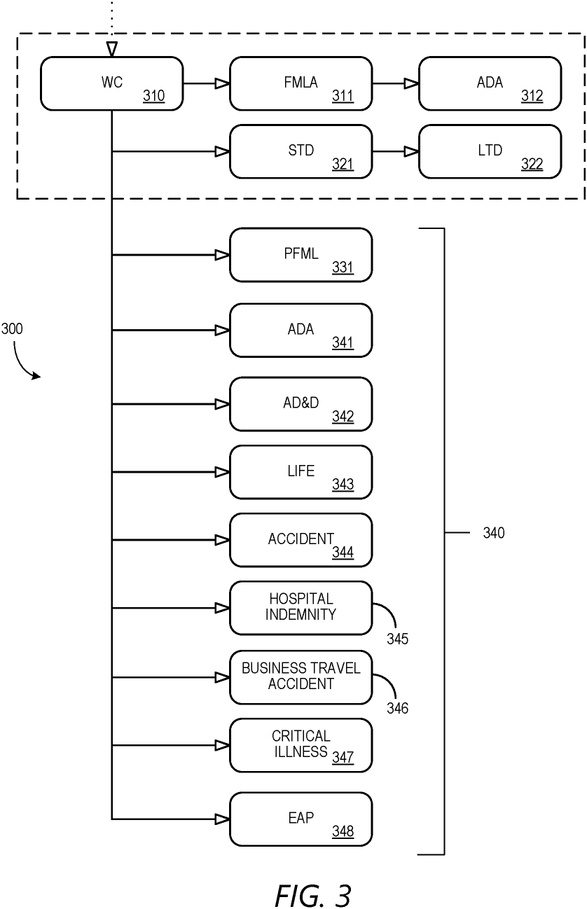

FIG. 3 illustrates 300 enhanced product connectivity for insurance claim processing according to some embodiments. As illustrated by a dashed line, a portion of the system including a WC claim 310, FMLA claim 311, ADA claim 312, STD claim 321, an LTD claim 322 may operate similarly as described in connection with FIG. 1. In this case, however, an enterprise may additionally support one or more supplemental resource allocation requests 340 (e.g., the resource allocation request 340 might be “supplemental” in that it provides a benefit in addition to - or instead of - other types of insurance). According to some embodiments, a Paid Family and Medical Leave (“PFML”) claim 331 may be initiated in conjunction with the WC claim 310 (if state law allows the two to run concurrently). In some cases, the WC claim 310 might be initiated or populated with information from another source or product (as illustrated by the dotted arrow in FIG. 3).

The supplemental resource allocation requests 340 might be associated with, for example, voluntary or group benefit insurance products or services. For example, the supplemental resource allocation request 340 might be associated with an initiation of an accommodation support for an employer and/or potential ADA claim 341. Similarly, the enterprise might automatically support initiation of an Accidental Death and Dismemberment (“AD&D”) claim 342 if there is an accidental death or dismemberment (e.g., loss of limb, eyesight, hearing, etc.) or an initiation of a life insurance claim 343 for an employee death. Other examples may include an automatic referral associated with an accident insurance claim 344 or a hospital indemnity claim 345. In some embodiments, the supplemental resource allocation request 340 comprises initiation of a Business Travel Accident (“BTA”) claim 346 if an individual is traveling for business. As another example, the supplemental resource allocation request 340 might be associated with a critical or catastrophic illness insurance claim 347 (e.g., insurance that provides direct lump-sum benefit when someone is diagnosed with cancer, a heart attack, a stroke, or another covered illness). By connecting the WC claim 310 with a wider array of group benefits products, an enterprise may create additional value for a client (e.g., an employer) and, in turn, drive incremental sales and retention.

According to some embodiments, a WC claim 310 may lead to a referral for Employee Assistance Program (“EAP”) resources 348 (e.g., on-site and virtual customized clinical services to help employees). For example, EAP resources 348 may help deliver counseling services; concierge-type services; etc. For employers, the benefits of providing EAP resources 348 may include a healthier and more productive workforce, etc. For employees, the services provided by EAP resources 348 might include: telephone support from counselors through a toll-free number for assessment and consultations; face-to-face confidential sessions (e.g., with a counselor, financial planner or legal advisor; help for legal concerns (e.g., when dealing with a home purchase, a divorce, or an adoption); financial planning (e.g., for retirement planning, budgets, saving for college, debt, etc.); online chat sessions with expert moderators; etc.. Note that some of the aspects described herein might require authorization by the employee to initiate a resource allocation request and/or to share information.

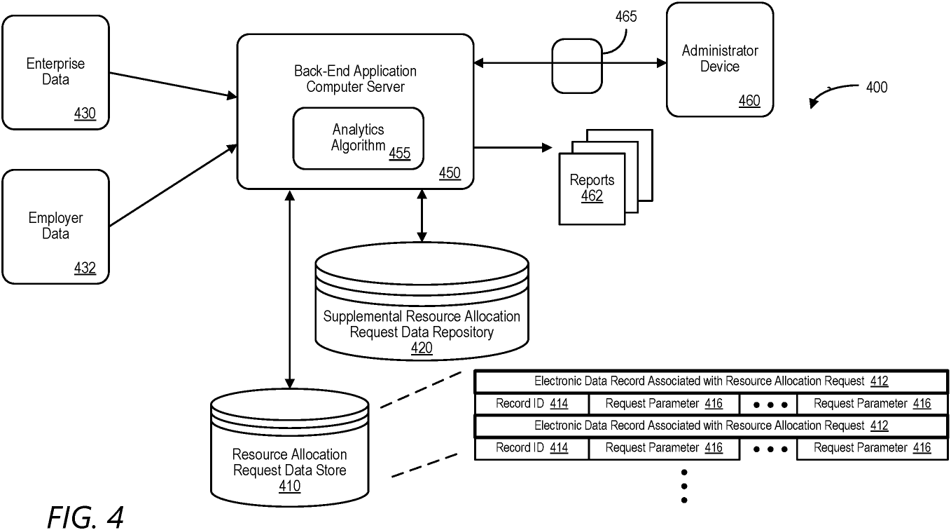

FIG. 4 is a high-level block diagram of an employee resource allocation request coordination framework or system 400 according to some embodiments of the present invention. In particular, the system 400 includes a back-end application computer server 450 that may access information in a resource allocation request data store 410 (e.g., storing a set of electronic records associated with a set of resource allocation requests 412, each record including, for example, one or more record identifiers 414, request parameters 416 such as absence dates, medical information, etc.). As used herein, the phrases “data store” and “data repository” may refer to any interface or apparatus able to exchange information. The back-end application computer server 450 may also exchange information with other data stores (e.g., a supplemental resource allocation request data repository 420) and utilize an analytics algorithm 455 (e.g., predictive or prescriptive analytics) to view, analyze, and/or update the electronic records. As used herein, the term analytics may refer to, for example, a machine learning and/or an artificial intelligence technique including computer algorithms that improve automatically through experience and the use of data (including, for example, Natural Language Processing (“NLP”) algorithms).

The back-end application computer server 450 may also exchange information with a remote administrator device 460 (e.g., via a firewall 465) and/or generate reports 462 including absence summaries, recommended improvements (e.g., insurance policy adjustments), etc. According to some embodiments, enterprise data 430 (e.g., information about insurance policies) and/or employer data 432 (e.g., claim information, Human Resources (“HR”) information, etc.) may be aggregated and provided to assist claim and leave coordination and/or transmitted the remote administrator device 460. In some embodiments, the remote administrator device 460 may transmit annotated and/or updated information to the back-end application computer server 450. Based on the updated information, the back-end application computer server 450 may adjust data in the resource allocation request data store 410, the supplemental resource allocation request data repository 420, and/or the change may be viewable via other remote administrator devices. Note that the back-end application computer server 450 and/or any of the other devices and methods described herein might be associated with a third party, such as a vendor that performs a service for an enterprise.

The back-end application computer server 450 and/or the other elements of the system 400 might be, for example, associated with a Personal Computer (“PC”), laptop computer, smartphone, an enterprise server, a server farm, and/or a database or similar storage devices. According to some embodiments, an “automated” back-end application computer server 450 (and/or other elements of the system 400) may facilitate the automated access and/or update of electronic records. As used herein, the term “automated” may refer to, for example, actions that can be performed with little (or no) intervention by a human.

As used herein, devices, including those associated with the back-end application computer server 450 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 450 may store information into and/or retrieve information from the resource allocation request data store 410 and the supplemental resource allocation request data repository 420. The data store 410 and supplemental resource allocation request data repository 420 may be locally stored or reside remote from the back-end application computer server 450. As will be described further below, the resource allocation request data store 410 may be used by the back-end application computer server 450 in connection with an interactive claim coordination interface to access and update electronic records. Although a single back-end application computer server 450 is shown in FIG. 4, any number of such devices may be included. Moreover, various devices described herein might be combined according to embodiments of the present invention. For example, in some embodiments, the back-end application computer server 450 and resource allocation request data store 410 might be co-located and/or may comprise a single apparatus and/or be implemented via a cloud-based computing environment.

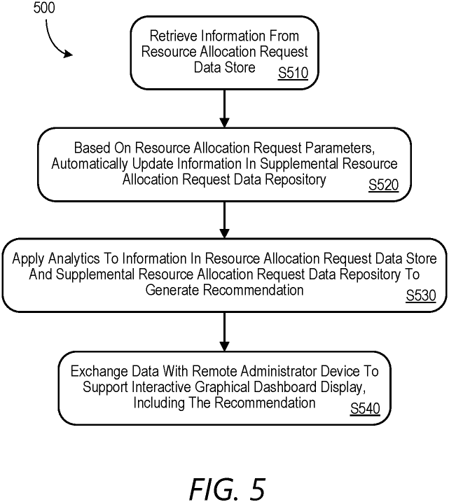

Note that the system 400 of FIG. 4 is provided only as an example, and embodiments may be associated with additional elements or components. FIG. 5 illustrates a method 500 that might be performed by some or all of the elements of the system 400 described with respect to FIG. 4, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S510, a computer processor of a back-end application computer server may retrieve information from a resource allocation request data store. The resource allocation data store may, for example, contain electronic records for a set of resource allocation requests associated with risk relationships (e.g., WC insurance policies) between the enterprise and an entity, and each electronic record may include an electronic record identifier and at least one resource allocation request parameter. According to some embodiments, the enterprise is an insurer, the entity is an employer, and the parties are employees of the employer. Moreover, the risk relationships might comprise insurance policies and/or agreements associated with insurance policies.

Based on resource allocation request parameters, the system may automatically update information in a supplemental resource allocation request data repository storing supplemental resource allocation requests from parties associated with the entity at S520. Note that the resource allocation requests in the resource allocation request data store may comprise WC insurance claims, and the supplemental resource allocation request data repository includes information about a group benefit insurance product. For example, the supplemental resource allocation request data repository may include information about an ADA leave request, an AD&D claim, a life insurance benefit, accident insurance, hospital indemnity insurance, business travel accident insurance, etc. According to some embodiments, the supplemental resource allocation request data repository includes information about an EAP.

At S530, the system may apply analytics to the information in the resource allocation request data store and the supplemental resource allocation request data repository to generate a recommendation (e.g., a Human Resources (“HR”) change, an injury prevention program, a suggested insurance policy change or addition, etc.). Some embodiments may generate insights that are unique and known because of the compilation of data across products. For example, the system might be able to look at total absence and claim activity across a workforce and identify areas that look out of pattern. At S540, the system may facilitate an exchange of data with a remote administrator or operator device to support an interactive graphical dashboard display, including the recommendation, via a distributed communication network. The interactive graphical dashboard display might include, for example, an absence summary employer dashboard. As will be described, the back-end application computer server might be additionally associated with some or all of leave management, resource planning, accommodation management, a health and wellness program, a Return To Work (“RTW”) program, employee safety, clinical solutions, etc.

In this way, an enterprise such as an insurer, may use disability, leave management and WC to leverage a substantial set of data for employees not actively at work - and use claims analytics and process optimization to deliver insights that drive greater employee health and productivity. Such a coordinated claims service and absence reporting solution for customers may help streamline compliance processes, reduce the administrative burden on employers, improve the employee and employer experience, and/or provide data driven insights to enhance workforce health and productivity.

With the automatic creation of corresponding leaves, only one claim (the WC claim) needs to be submitted, making it more efficient for the employer and employee because they no longer need to call in a second time to set up a leave for the same absence. In addition, auto creation may also improve compliance and tracking. The coordination of information across WC and leave may help ensure that WC decisions are leveraged to make leave decisions, saving the employee time and often money by eliminating the need to submit medical information multiple times. In addition, this streamlined process may help expedite approvals for the claimant.

If an employer has 24-hour STD coverage, an STD claim may be initiated in conjunction with the leave. If the employer does not have 24-hour STD coverage, the denial of a WC claim may automatically trigger the creation of an STD claim. Moreover, the system may initiate an LTD claim, as appropriate, and upon receipt of a claimant authorization, use medical information on file from the WC claim to expedite review of the LTD claim. This makes it more efficient for the employee by eliminating the need to set up a new disability claim, and it provides accurate financial tracking for the employer.

Embodiments may provide holistic absence reporting with an all-in view of leave, disability, and lost-time WC claims for easy analysis, reducing administration and improving productivity planning through an employer dashboard. Summary and trending views may show absence by product. There may also be detailed absence information available at the claim-level for the employer (e.g., to do their own analysis). A claim inquiry report may also be provided with WC, leave and disability claim history for an individual employee.

By connecting and managing all absences - work-related and not - an enterprise may help employers increase productivity and lower costs. For example, a WC claim with lost time from work may be reported by an employer. In response, FMLA may be initiated by the enterprise in coordination with the WC claim to track time missed from work. If the WC claim is approved and lost wages are paid, this information will flow to approve the leave. If the WC claim is denied, the enterprise may initiate consideration of an STD claim and use any WC medical on file (upon receipt of authorization from the employee).

Consider, for example, an employee who sustains a fall injury from a ladder, and as a result will be out of work for the next four to six weeks. A WC claim is initiated by the employer for the lost time and reviewed for compensability. This triggers a seamless creation of a leave of absence where FMLA is reviewed based upon the WC lost time. The seamless integration between WC and leave mitigates the need for the employer/employee to open a leave separately.

As another example, an employer may be evaluating absences for workforce planning. Through integrated reporting, they are able to download a holistic real-time report with WC, leave, and disability claims to evaluate employee absences. The employer may engage proactively on accommodation discussions and Return To Work (“RTW”) planning. With coordinated claim management, the employer may efficiently manage a RTW program and get people back to work.

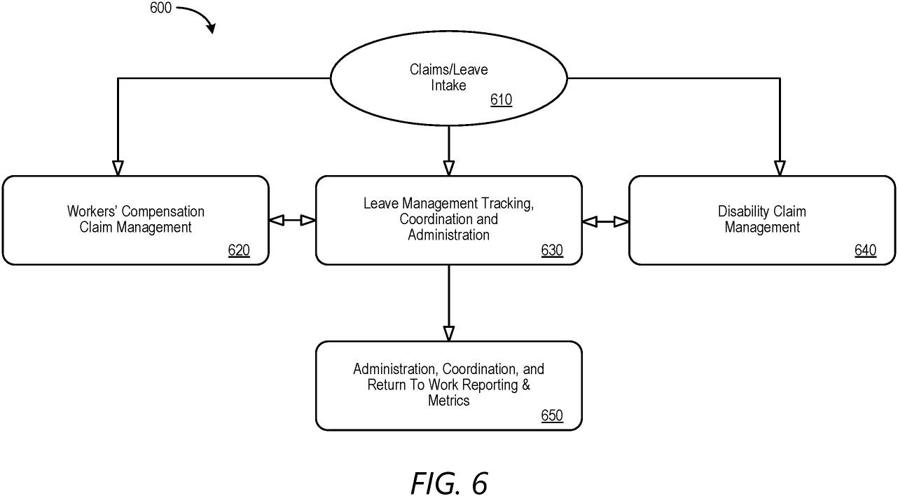

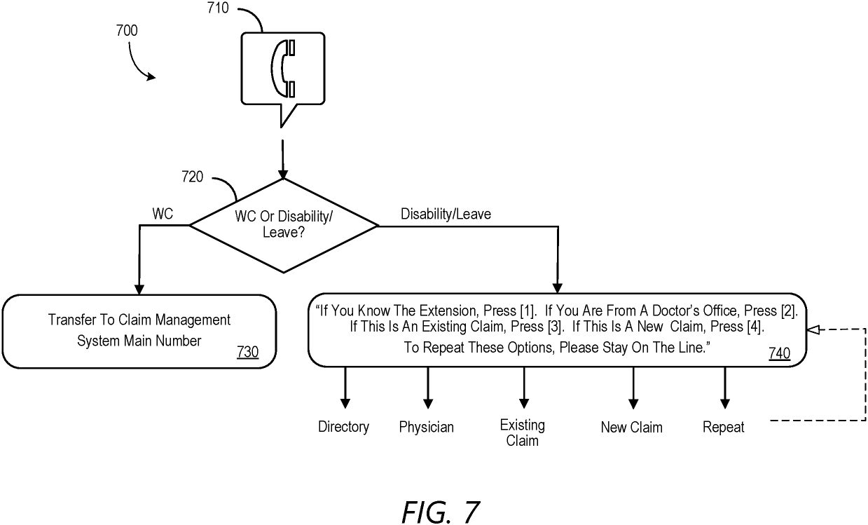

FIG. 6 illustrates 600 a connected claim experience in accordance with some embodiments. Upon claim/leave intake 610 (e.g., via a single telephone number to report any absence type as described with respect to FIG. 7), WC claim management process 620, leave management tracking, coordination, and administration 630, and disability claim management 640 processes may be initiated as appropriate. This may result in the auto-initiation of job-protected leave for WC and disability claims and the ongoing adjudication of leave events using WC and disability claim information. Moreover, administration, coordination, and RTW reporting and metrics 650 may provide seamless identification of STD and LTD from WC lost time claims may be performed.

FIG. 7 is an information flow 700 that may let a single intake system receive claims (regardless of reason) according to some embodiments. A single telephone number 710 (e.g., a disability and absence management service) may route 720 WC claims to a claim management system main telephone number 730. Moreover, disability/leave claims may be routed 720 to a recorded message 740 asking the caller to define the call as a request for a directory, a physician inquiry, an existing claim, a new claim, a particular language, etc. As illustrated by the dashed line in FIG. 7, the caller can arrange to hear the recorded message 740 again.

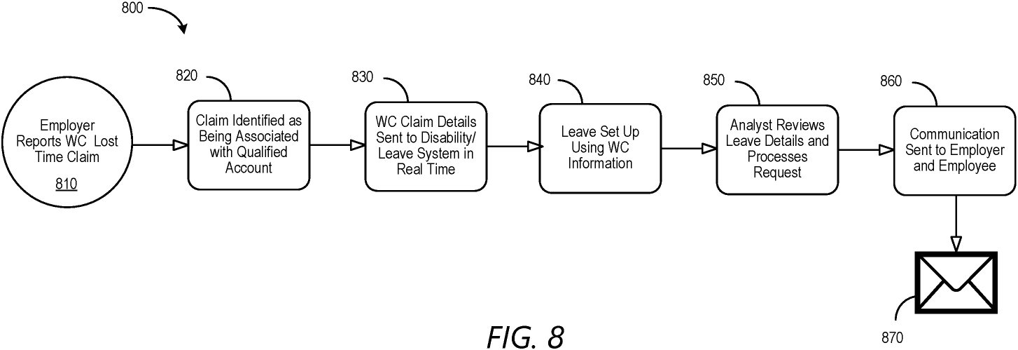

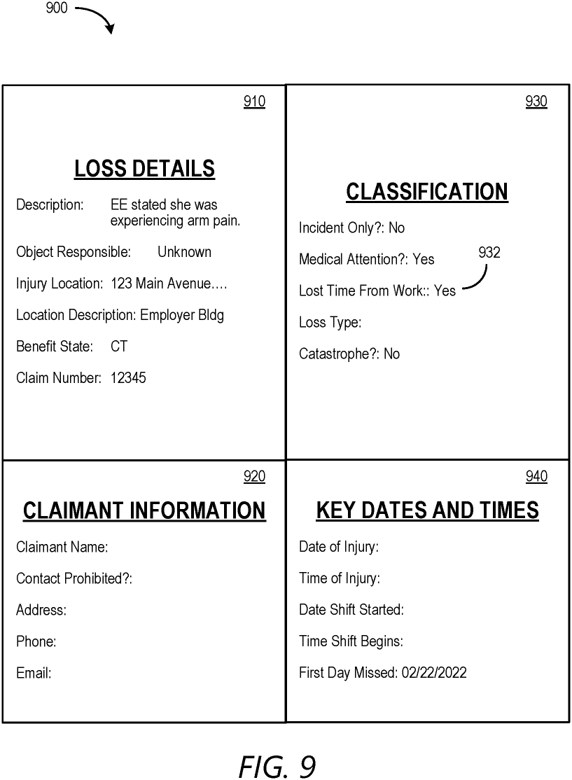

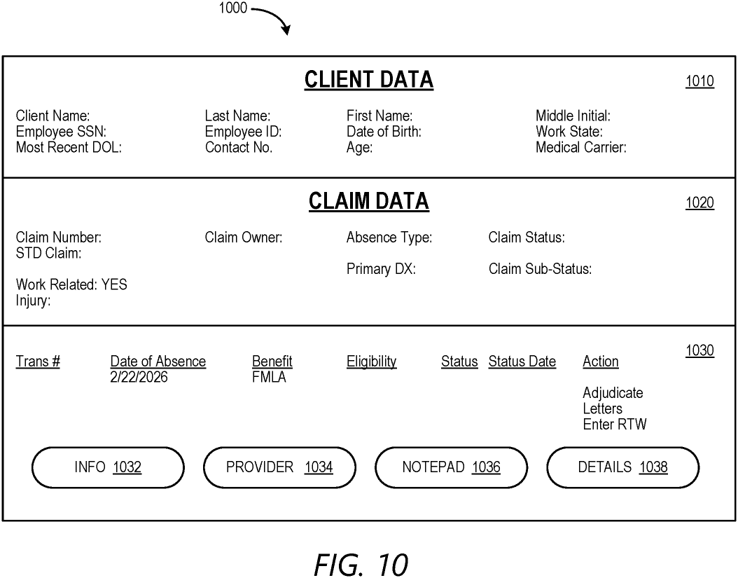

FIG. 8 is a workflow 800 in accordance with some embodiments. The workflow 800 may be associated with a new workers’ compensation lost time claim reported from an employer to an insurer 810. The claim may be identified as being associated with a qualified account 820 (e.g., as described in connection with FIGS. 9 and 10) and WC claim details may be sent to a disability/leave claim system in substantially real-time 830. The leave may then be set up using WC information 840 and an analyst may review the leave details to process the request 850. A communication may then be sent to the employer and/or employee 860 (e.g., an email or postal letter 870). In this way, embodiments may provide a seamless integration between WC claims and leave requests (mitigating the need for the employer/employee to open a leave separately).

FIG. 9 is a display 900 that shows what might trigger a creation of a leave from a WC claim in accordance with some embodiments. The display 900 includes loss details 910 (e.g., a description, an injury location, a claim number, etc.), claimant information 920 (e.g., a claimant name, address, phone number, etc.), classification data 930 (e.g., an indication of whether medical attention was required, etc.), and key dates and times 940 (e.g., a date of injury, a time of injury, shift information, etc.). If a claim is from a qualified account and a “Lost Time From Work” indication 932 indicates “Yes,” 9 the creation of a leave from a WC claim may be triggered via an information feed in substantially real time.

FIG. 10 shows what an employee leave request 1000 might look like according to some embodiments. Client data 1010 might include a client name, employee Social Security Number (“SSN”), employee identifier, etc. Claim data 1020 might include a claim number, a claim owner, a claim status, etc. Claim details 1030 might include a transaction identifier, a date of absence, a benefit type, a status, an action, a predicted RTW date, a RTW date, etc. The request 1000 may include an information received history selection 1032, a provider information selection 1034, a notepad selection 1036, a workers’ compensation selection, a show details selection 1038, etc.

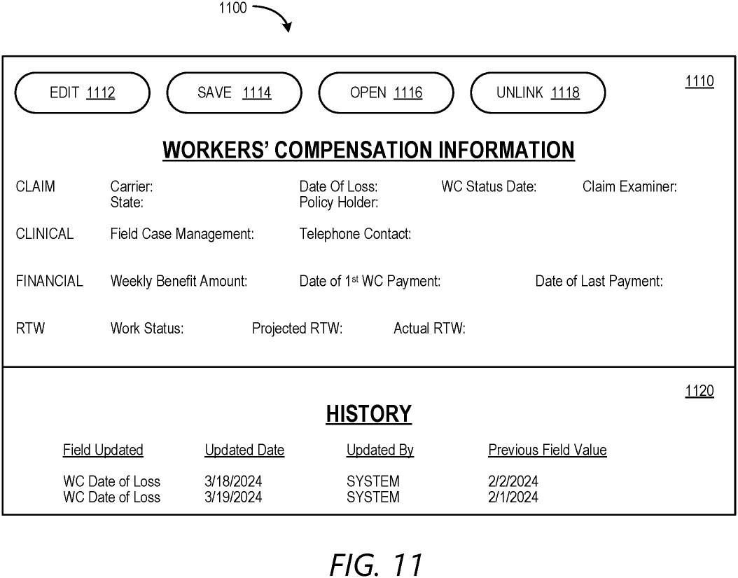

FIG. 11 illustrates 1100 some workers’ compensation information that might be displayed in accordance with some embodiments. A workers’ compensation information area 1110 may include claim information (e.g., a carrier, a state, a date of loss, a claim examiner, etc.); clinical information (e.g., a field case management indication, a telephonic case management information, etc.); financial information (e.g., a weekly indemnity benefit amount, a date of first WC payment, etc.); RTW information (e.g., work status, a projected RTW date, an actual RTW date, etc.); etc. A history area 1120 may show updates that have been made to the WC claim (e.g., what field was updated, when it is was updated, who updated the field, etc.). Selection of an “Edit” icon 1112, “Save” icon 1114, “Open” icon 1116, or “Unlink” icon 1118 may result in the performance of those functions.

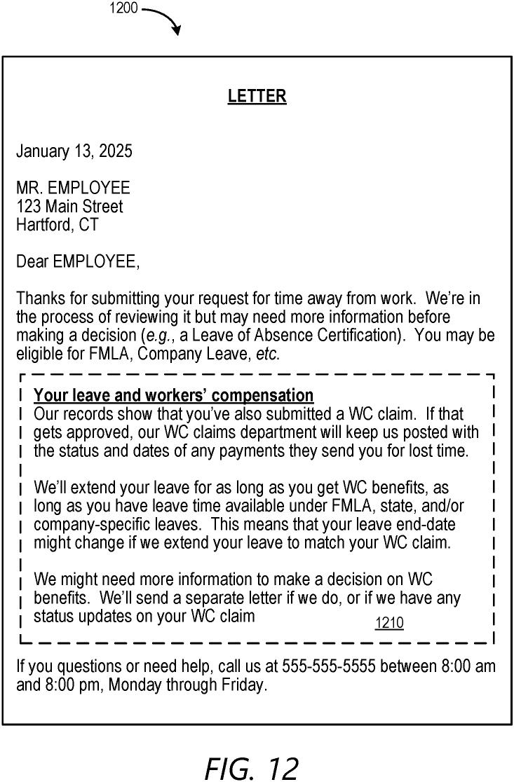

FIG. 12 is an example of a letter 1200 that might be sent to an employee according to some embodiments. The letter 1200 might be automatically generated (e.g., by inserting a claimant name, contact information for a claim handler, etc. along with various text as appropriate). According to some embodiments, the letter 1200 includes specific information 1210 (as illustrated by a dashed box in FIG. 12) about a claimant’s leave and WC claim.

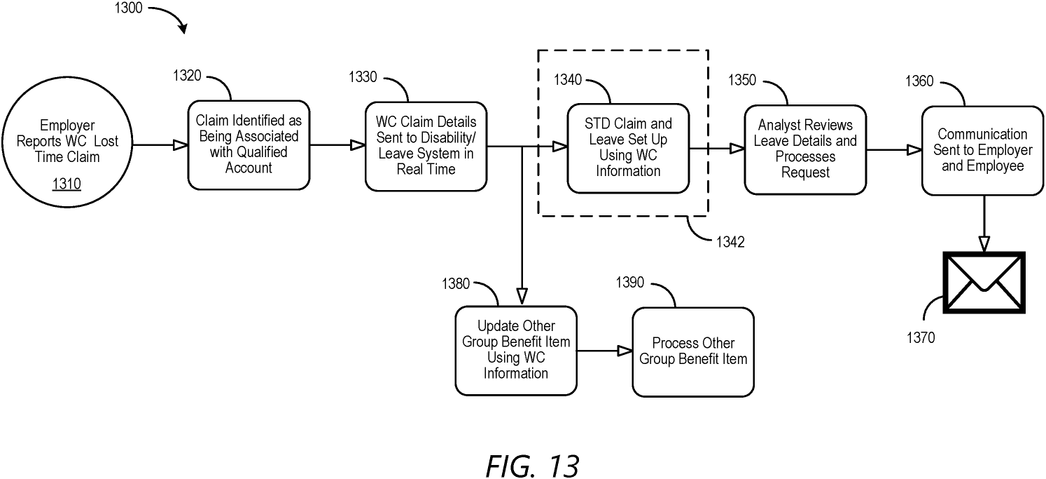

FIG. 13 is an information flow 1300 for a new workers’ compensation lost time claim in accordance with some embodiments. The information flow 1300 may be associated with a new workers’ compensation lost time claim reported from an employer to an insurer 1310. The claim may be identified as being associated with a qualified account 1320 (e.g., as described in connection with FIGS. 9 and 10) and WC claim details may be sent to a disability/leave claim system in substantially real-time 1330. The STD claim leave may then be set up using WC information 1340 (as illustrated by the dashed box 1342 in FIG. 13), and an analyst may review the details to process the request 1350 (e.g., in compliance with Federal and state regulations. A communication may then be sent to the employer and/or employee 1360 within five business days of claim initiation (e.g., an email or postal letter 1370). Moreover, at 1380 WC information may be used to update another group benefit item (e.g., associated with AD&D, life insurance, accident, critical illness, etc.) before that item is processed at 1390. In this way, embodiments may provide a seamless integration between WC claims, STD, leave requests (mitigating the need for the employer/employee to report STD and leave requests in addition to the WB claim), and other types of group benefit insurance offered by an employer.

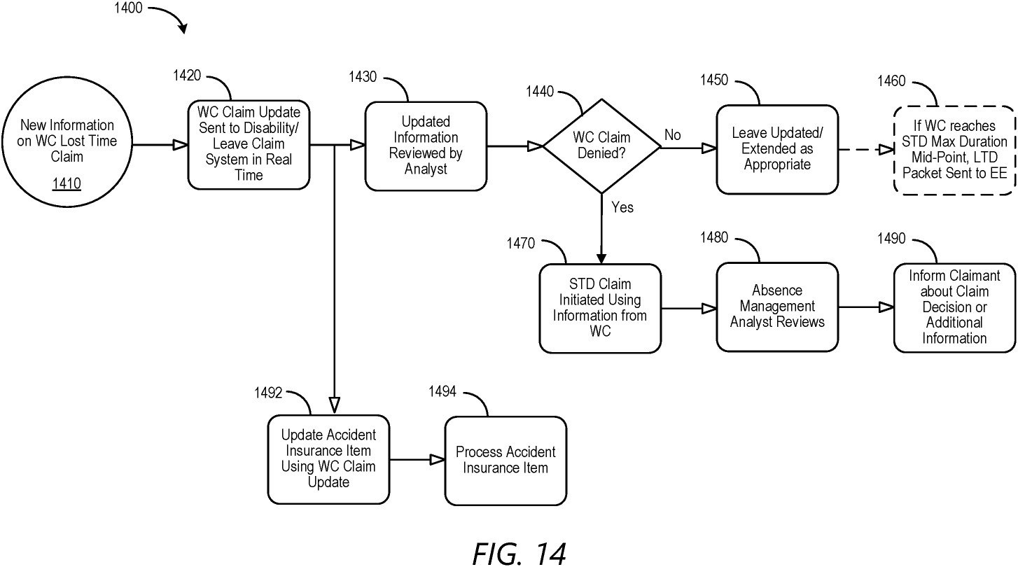

FIG. 14 is an information flow 1400 for ongoing updates to a workers’ compensation lost time claim according to some embodiments (e.g., a WC exclusion to disability). New information about a WC lost time claim may be received 1410 and a WC update may be sent to disability/leave claim system in substantially real time 1420. The updated information is reviewed by an analyst 1430. If the WC claim is not denied 1440, the leave may be updated/extended as appropriate 1450. If the WC claim reaches an STD maximum duration mid-point, an LTD packet may be sent to the employee 1460. If the WC claim is denied 1440, an STD claim may be initiated using information from WC 1470. An absence management analyst may review the STD claim and determine if additional information is needed 1480. The analyst may then call the claimant to inform them of the claim decision and/or ask for any additional information needed to make a decision 1490. Moreover, at 1492 the WC claim update may be used populate data for an accident insurance item (e.g., dates and locations associated with an accident insurance claim) before that item is processed at 1494.

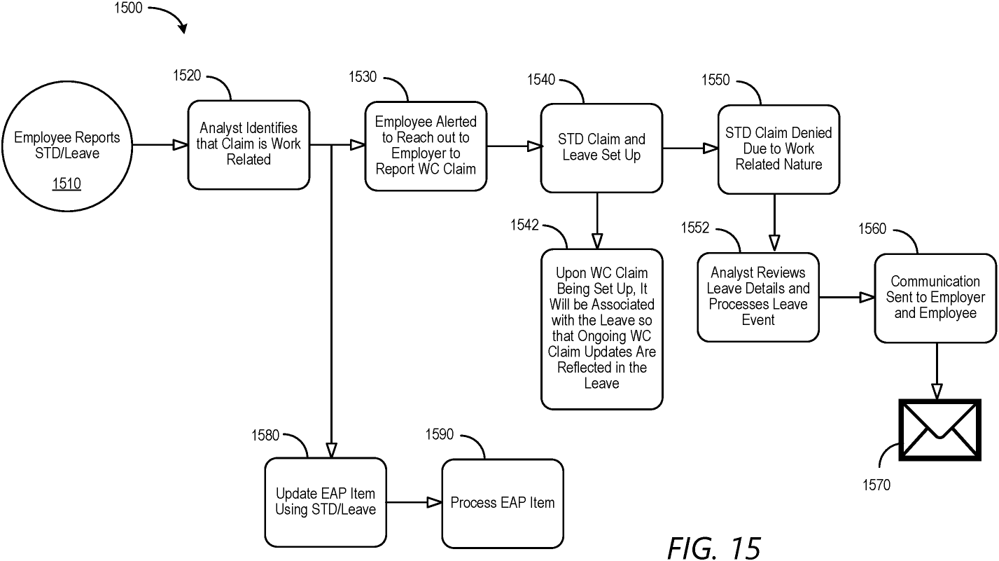

FIG. 15 is an information flow 1500 for a new, work-related, STD claim in accordance with some embodiments. After an employee reports STD/leave 1510, an analyst may identify that a claim is work related 1520. The employee may then be alerted to reach out to his or her employer to report a WC claim 1530. The STD claim and leave is set up 1540 and associated with leave that ongoing WC claim updates are reflected in the leave 1542. If the claim is denied due to the work-related nature of the injury 1550, the analyst may review the leave details and process the leave event 1552 in compliance with Federal and state regulations. A communication may then be sent to the employer and/or employee 1560 within five business days of claim initiation (e.g., an email or postal letter 1570). Moreover, at 1580 the reported STD/leave may be used populate data for an EAP item (e.g., to determine if the employee qualifies for an assistance program benefit) before that item is processed at 1590. The seamless integration between WC, STD/leave, and the EAP may mitigate the need for ongoing medical updates to be provided in support of the leave or the EAP.

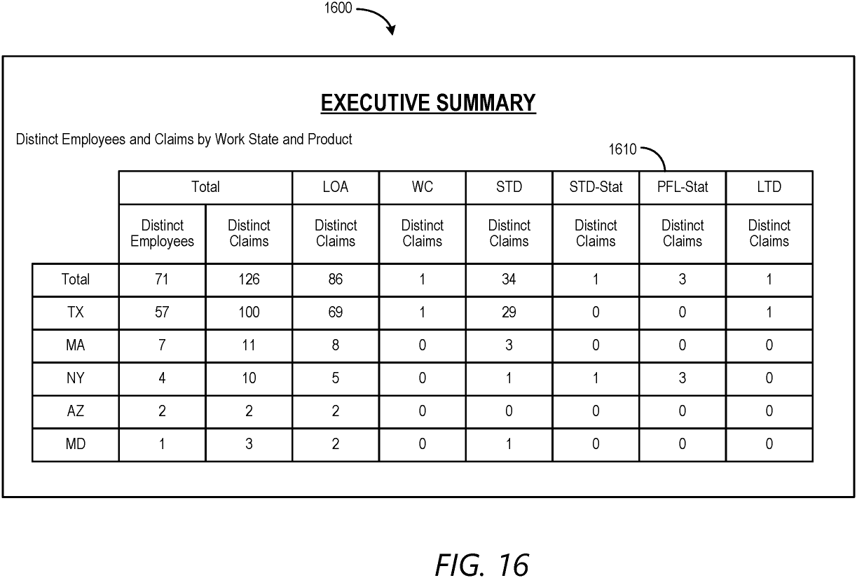

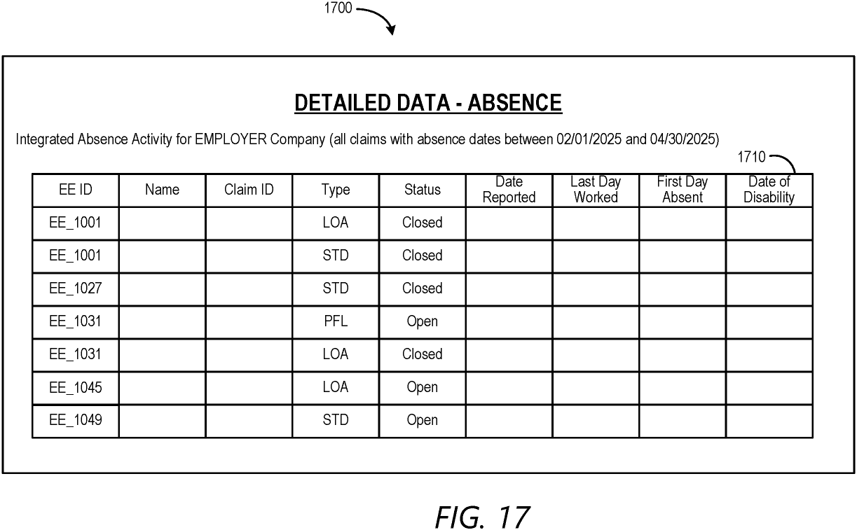

Note that various reporting capabilities may be available (e.g., via a group benefits portal). For example, FIG. 16 is an executive summary display 1600 for integrated absence activity that may be provided to an employer according to some embodiments. The display 1600 includes a table 1610 showing distinct employees and claims by work state and product. Additional pages might show: distinct claims by product type by reported month; a distinct leaves by leave type (continuous versus intermittent); distinct standalone leaves by type (continuous versus intermittent); etc. FIG. 17 is a more detailed absence display 1700 in accordance with some embodiments. The display 1700 includes a table 1710 showing integrated absence activity for an employer company (e.g., all claims with absence dates within a particular range) including an employee identifier, an employee name, a claim identifier, a claim type, a status, etc.

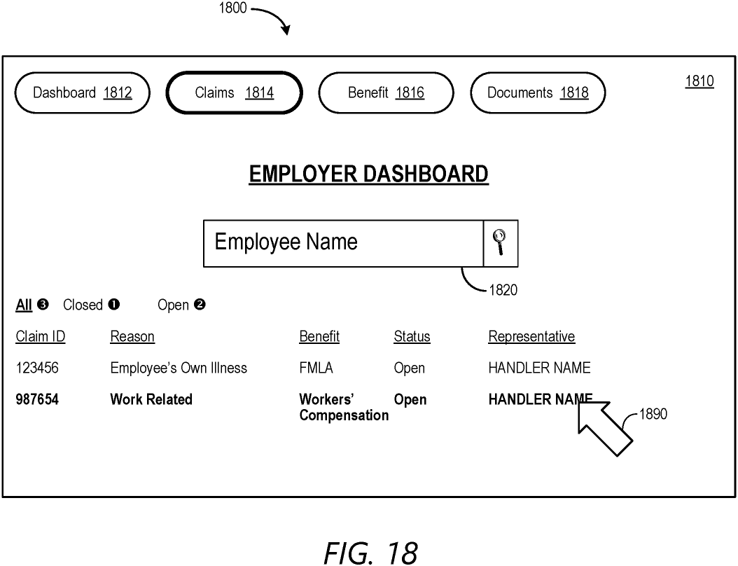

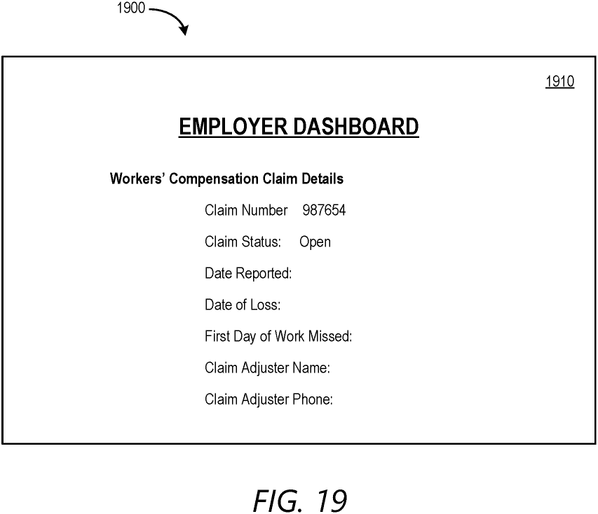

FIG. 18 is an individual employee multiple claims inquiry dashboard display 1800 according to some embodiments. The display 1800 includes an employer dashboard 1810 with an employee name search box 1820 and options to display another dashboard 1812, claims 1814, benefits 1816, and documents 1818. The display 1800 can show all search results, closed search results, and/or open search results. For each claim, the display 1800 might show a claim identifier, a reason, a benefit type, various claim dates, a claim status, a representative, etc. Selection of a claim (e.g., via a touchscreen or computer mouse pointer 1890) may result in the display of additional information about that particular claim. For example, FIG. 19 is an individual employee single claim inquiry display 1900 in accordance with some embodiments. The display 1900 includes employer dashboard information 1910 for WC claim details, such as a claim number, a claim status, a date reported, a date of loss, a claim adjuster name, etc.

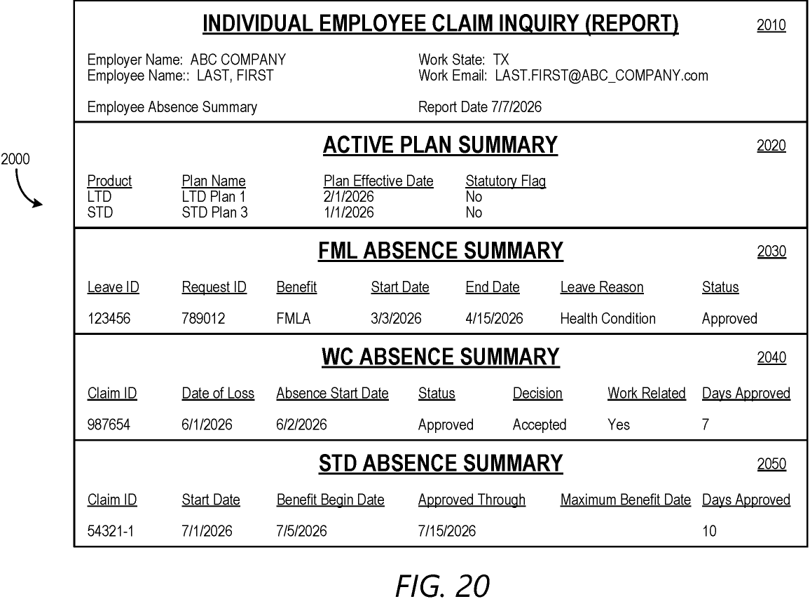

FIG. 20 is a dashboard report display 2000 according to some embodiments. The display 2000 includes an individual employee claim inquiry (report) area 2010 including an employer name, an employee name, a work state, report date, etc. An active plan summary area 2020 may include a product type, a plan name, a plan effective date, etc. A FML absence summary 2030 may include a leave identifier, a request identifier, a benefit, relevant dates, a leave reason, a leave status, etc. A SC absence summary area 2040 may include a claim identifier, a date of loss, a status, a decision, etc. An STD absence summary area 2050 may include a claim identifier, a start date, a maximum benefit date, a number of days that have been approved by the enterprise, etc.

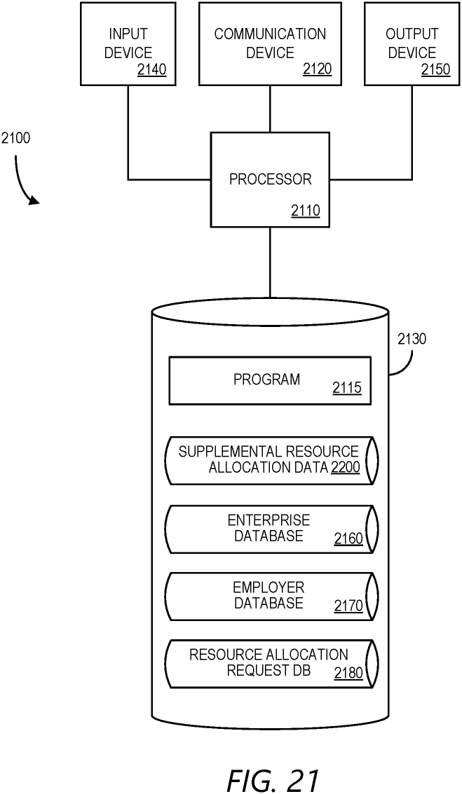

The embodiments described herein may be implemented using any number of different hardware configurations. For example, FIG. 21 illustrates an apparatus 2100 that may be, for example, associated with the system 400 described with respect to FIG. 4. The apparatus 2100 comprises a processor 2110, such as one or more commercially available Central Processing Units (“CPUs”) in the form of one-chip microprocessors, coupled to a communication device 2120 configured to communicate via a communication network (not shown in FIG. 21). The communication device 2120 may be used to communicate, for example, with one or more remote administrator devices (e.g., PCs and smartphones), administrator computers, and/or third-party platforms. Note that data exchanged via the communication device 2120 may utilize security features, such as encryption between an emergency responder and an internal network of an insurance company and/or telematics enterprise. The security features might be associated with, for example, web servers, firewalls, and/or PCI infrastructure. The apparatus 2100 further includes an input device 2140 (e.g., a mouse and/or keyboard to enter information about data sources, absence rules, employees, etc.) and an output device 2150 (e.g., to output reports regarding absences, summary logs, recommended actions, alerts, etc.).

The processor 2110 also communicates with a storage device 2130. The storage device 2130 may comprise any appropriate information storage device, including combinations of magnetic storage devices (e.g., a hard disk drive), optical storage devices, mobile telephones, and/or semiconductor memory devices. The storage device 2130 stores a program 2115 and/or employee resource allocation request coordination framework or application for controlling the processor 2110. The processor 2110 performs instructions of the program 2115, and thereby operates in accordance with any of the embodiments described herein. For example, the processor 2110 may retrieve information from a resource allocation request database 2180 that contains electronic records for a set of resource allocation requests associated with risk relationships between an enterprise and an entity. Based on resource allocation request parameters, the processor 2110 may automatically update information in supplemental resource allocation request data 2200 (storing supplemental resource allocation requests from parties associated with the entity). The processor 2110 may then apply analytics to the information in the resource allocation request database 2180 and the supplemental resource allocation request data 2200 to generate a recommendation. The processor 2110 may also facilitate an exchange of data with a remote administrator device to support an interactive graphical dashboard display, including the recommendation, via a distributed communication network.

The program 2115 may be stored in a compressed, uncompiled and/or encrypted format. The program 2115 may furthermore include other program elements, such as an operating system, a database management system, and/or device drivers used by the processor 2110 to interface with peripheral devices.

As used herein, information may be “received” by or “transmitted” to, for example: (i) the apparatus 2100 from another device; or (ii) a software application or module within the apparatus 2100 from another software application, module, or any other source.

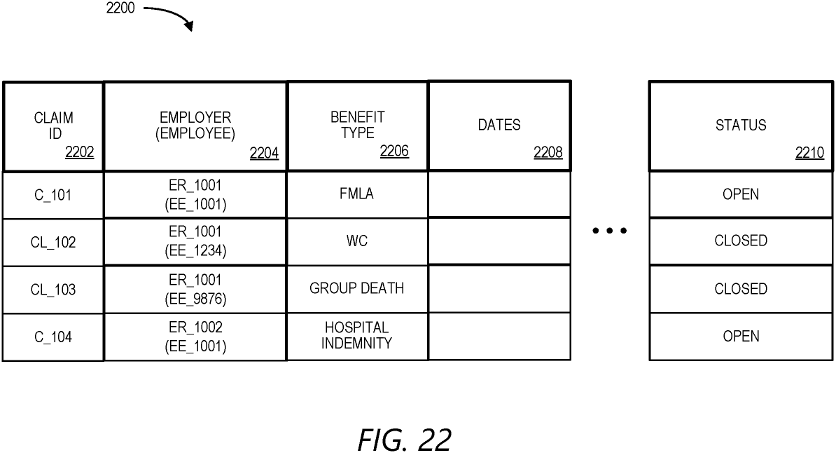

In some embodiments (such as shown in FIG. 21), the storage device 2130 further stores the resource allocation request data 2200 (e.g., associated with group benefits), an enterprise database 2160 (e.g., storing insurance policy information), an employer database 2170 (e.g., HR information), and resource allocation request database (e.g., storing WC claim data). An example of data that might be used in connection with the apparatus 2100 will now be described in detail with respect to FIG. 22. Note that the data described herein is only an example, and additional and/or different information may be stored therein. Moreover, various databases might be split or combined in accordance with any of the embodiments described herein. For example, the resource allocation request database 2180 and supplemental resource allocation data 2200 might be combined and/or linked to each other within the program 2115.

Referring to FIG. 22, a table is shown that represents the resource allocation request data 2200 that may be stored at the apparatus 2100 according to some embodiments. The table may include, for example, entries associated with claims being coordinated by an enterprise. The table may also define fields 2202, 2204, 2206, 2208, 2210 for each of the entries. The fields 2202, 2204, 2206, 2208, 2210 may, according to some embodiments, specify: a claim identifier 2202, an employer and employee 2204, a benefit type 2206, dates 2208, and a status 2210. The resource allocation request data 2200 may be created and updated, for example, based on information electrically received from various data sources (e.g., claim reports) that are associated with a business such as a client of an insurance enterprise.

The claim identifier 2202 may be, for example, a unique alphanumeric code associated with a claim (or resource allocation request) being coordinated. The employer and employee 2204 might indicate an insured and an employee of the insured. The benefit type 2206 might indicate a type of request being processed (e.g., ADA, FML, AD&D, etc.). The dates 2208 might indicate start and/or end dates of an absence and might be set up based on information about a WC claim in the resource allocation request database 2180. The status 2210 might indicate, for example, that a claim is open or has been closed.

Thus, embodiments may provide an automated and efficient way to coordinate supplemental employee resource allocation requests in a way that provides fast and useful results (and that allows for flexibility and effectiveness when implementing those results). By integrating technology, services and insurance protections, embodiments described herein may enable a more holistic way to improve employee health and productivity, lower total cost, and reduce administrative burdens and regulatory risks. Employers may achieve increased productivity, lower administration costs, reduced compliance risk, etc. Employees may achieve a seamless coordination of benefits, streamlined claims processing, enhanced service and satisfaction, etc.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises and types of insurance, embodiments may instead be associated with other types of enterprises and insurance in addition to and/or instead of those described herein (e.g., automobile insurance). Similarly, although certain types of parameters were described in connection some embodiments herein, other types of parameters might be used instead of, or in addition to, those mentioned.

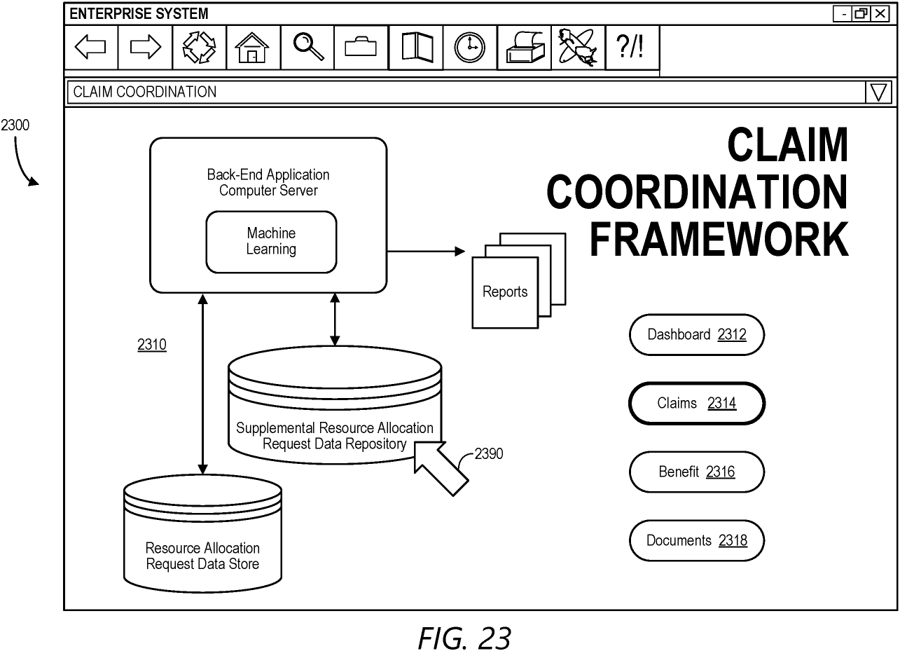

Note that the displays and devices illustrated herein are only provided as examples, and embodiments may be associated with any other types of interfaces. For example, FIG. 23 is a claim coordination framework display 2300 including graphical representations of elements 2310 of an employee resource allocation request coordination framework. Selection of a portion or element of the display 2300 might result in the presentation of additional information about that portion or device (e.g., a popup window presenting a more detailed view of mappings or other specifics of the system implementation) or let an administrator enter or annotate additional information about the employee resource allocation request coordination framework (e.g., based on his or her experience and expertise). Selection of a “Dashboard” icon 2312, “Claims” icon 2314, “Benefit” icon 2316, or a “Documents” icon 2318 (e.g., by touchscreen or computer mouse pointer 2390) might cause the system or platform to switch to one of those dashboard displays. Note that the displays and devices illustrated herein are only provided as examples, and embodiments may be associated with any other types of user interfaces.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A resource allocation request coordination system implemented via a back-end application computer server associated with an enterprise, comprising:
(a) a resource allocation request data store that contains electronic records for a set of resource allocation requests associated with risk relationships between the enterprise and an entity, each electronic record including an electronic record identifier and at least one resource allocation request parameter;
(b) a supplemental resource allocation request data repository storing supplemental resource allocation requests from parties associated with the entity;
(c) the back-end application computer server, coupled to the resource allocation request data store and the supplemental resource allocation request data repository, including:
a computer processor, and
a computer memory, coupled to the computer processor, storing instructions that, when executed by the computer processor, cause the back-end application computer server to:
(i) retrieve information from the resource allocation request data store,
(ii) based on resource allocation request parameters, automatically update information in the supplemental resource allocation request data repository, and
(iii) apply analytics to the information in the resource allocation request data store and the supplemental resource allocation request data repository to generate a recommendation; and
(d) a communication port coupled to the back-end application computer server to facilitate an exchange of data with a remote administrator device to support an interactive graphical dashboard display, including the recommendation, via a distributed communication network.

2. The system of claim 1, wherein the enterprise is an insurer, the entity is an employer, and the parties are employees of the employer.

3. The system of claim 2, wherein the risk relationships are associated with at least one of: (i) workers’ compensation insurance policies, and (ii) a workers’ compensation service agreement with an employer.

4. The system of claim 3, wherein the resource allocation requests in the resource allocation request data store comprise workers’ compensation insurance claims.

5. The system of claim 4, wherein the supplemental resource allocation request data repository includes information about a group benefit insurance product or service.

6. The system of claim 5, wherein the supplemental resource allocation request data repository includes information about at least one of: (i) an Americans with Disabilities Act (“ADA”) leave request, (ii) an Accidental Death and Dismemberment (“AD&D”) claim, (iii) a life insurance benefit, (iv) accident insurance, (v) hospital indemnity insurance, (vi) business travel accident insurance, (vii) critical illness insurance, and (viii) Paid Family Medical Leave (“PFML”).

7. The system of claim 4, wherein the supplemental resource allocation request data repository includes information about an Employee Assistance Program (“EAP”).

8. The system of claim 4, wherein the interactive graphical dashboard display includes an absence summary employer dashboard.

9. The system of claim 4, wherein the back-end application computer server is associated with at least one of: (i) leave management, (ii) resource planning, (iii) accommodation management, (iv) a health and wellness program, (v) a Return To Work (“RTW”) program, (vi) employee safety, and (vii) clinical solutions.

10. A computerized resource allocation request coordination method implemented via a back-end application computer server associated with an enterprise, comprising:
retrieving, by a computer processor of the back-end application computer server, information from a resource allocation request data store that contains electronic records for a set of resource allocation requests associated with risk relationships between the enterprise and an entity, each electronic record including an electronic record identifier and at least one resource allocation request parameter;
based on resource allocation request parameters, automatically updating information in a supplemental resource allocation request data repository storing supplemental resource allocation requests from parties associated with the entity;
applying analytics to the information in the resource allocation request data store and the supplemental resource allocation request data repository to generate a recommendation; and
facilitating an exchange of data with a remote administrator device to support an interactive graphical dashboard display, including the recommendation, via a distributed communication network.

11. The method of claim 10, wherein the enterprise is an insurer, the entity is an employer, and the parties are employees of the employer.

12. The method of claim 11, wherein the risk relationships are associated with at least one of: (i) workers’ compensation insurance policies, and (ii) a workers’ compensation service agreement with an employer.

13. The method of claim 12, wherein the resource allocation requests in the resource allocation request data store comprise workers’ compensation insurance claims.

14. The method of claim 13, wherein the supplemental resource allocation request data repository includes information about a group benefit insurance product or service.

15. The method of claim 14, wherein the supplemental resource allocation request data repository includes information about at least one of: (i) an Americans with Disabilities Act (“ADA”) leave request, (ii) an Accidental Death and Dismemberment (“AD&D”) claim, (iii) a life insurance benefit, (iv) accident insurance, (v) hospital indemnity insurance, (vi) business travel accident insurance, (vii) critical illness insurance, and (viii) Paid Family Medical Leave (“PFML”).

16. The method of claim 13, wherein the supplemental resource allocation request data repository includes information about an Employee Assistance Program (“EAP”).

17. The method of claim 13, wherein the interactive graphical dashboard display includes an absence summary employer dashboard.

18. The method of claim 13, wherein the back-end application computer server is associated with at least one of: (i) leave management, (ii) resource planning, (iii) accommodation management, (iv) a health and wellness program, (v) a Return To Work (“RTW”) program, (vi) employee safety, and (vii) clinical solutions.

19. A non-transitory, computer-readable medium storing instructions, that, when executed by a processor, cause the processor to perform a resource allocation request coordination method implemented via a back-end application computer server associated with an enterprise, the method comprising:
retrieving, by a computer processor of the back-end application computer server, information from a resource allocation request data store that contains electronic records for a set of resource allocation requests associated with risk relationships between the enterprise and an entity, each electronic record including an electronic record identifier and at least one resource allocation request parameter;
based on resource allocation request parameters, automatically updating information in a supplemental resource allocation request data repository storing supplemental resource allocation requests from parties associated with the entity;
applying analytics to the information in the resource allocation request data store and the supplemental resource allocation request data repository to generate a recommendation; and
facilitating an exchange of data with a remote administrator device to support an interactive graphical dashboard display, including the recommendation, via a distributed communication network.

20. The medium of claim 19, wherein the enterprise is an insurer, the entity is an employer, the parties are employees of the employer, the risk relationships are associated with workers’ compensation insurance policies, and the resource allocation requests in the resource allocation request data store comprise workers’ compensation insurance claims.

21. The medium of claim 20, wherein the supplemental resource allocation request data repository includes information about at least one of: (i) a group benefit insurance product, (ii) an Americans with Disabilities Act (“ADA”) leave request, (iii) an Accidental Death and Dismemberment (“AD&D”) claim, (iv) a life insurance benefit, (v) accident insurance, (vi) hospital indemnity insurance, (vii) business travel accident insurance, (viii) critical illness insurance, (ix) Paid Family Medical Leave (“PFML”), and (x) an Employee Assistance Program (“EAP”).
